(19) United States
(12) Patent Application Publication
(10) Pub. No.: US 2024/0202621 A1
(43) Pub. Date: Jun. 20, 2024

(54) Method of Using a Software Application to Create a Game Plan for Youth Sports

(71) Applicant: Zebrick Roach, Seattle, WA (US)

(72) Inventor: Zebrick Roach, Seattle, WA (US)

(21) Appl. No.: 18/539,333

(22) Filed: Dec. 14, 2023

Related U.S. Application Data
(60) Provisional application No. 63/432,399, filed on Dec. 14, 2022.

(51) Int. Cl. G06Q 10/0631

(52) U.S. Cl. CPC G06Q 10/063112

(57) ABSTRACT

A method for using a software application permits a user to select youth baseball and softball league players for offense and defense positions using user-determined settings, preset rules, league rules, external inputs and other user-determined conditions that allow the user to set a plurality of positive and negative selection biases for each player. The software application uses information provided by the user to generate color-coded displays and other displays reflecting the positive and negative selection biases assigned in light of previous and future roster selections. The method also allows auto-selection of players for offense and defense positions based on the set positive and negative selection biases and external inputs, including information from external sources. The method permits the user to use the software application to create and use predictive information and pre-set development metrics for players. Color coded displays track play-time equity between players and other displays permit the user to make selections to benefit player improvement.

### BACKGROUND OF THE INVENTION

Creating a game plan for baseball and softball can be complicated. For a single inning, there are over 79 million permutations for setting 12 players into 9 positions. The complication is made greater when the players are young. In youth baseball, a coach is faced with a range of competing opportunities and limitations, such as the desire to win, a wide range in player skills on a team, limits placed on the amount of time young players may play at a certain position based on league rules, pressure from parents, and the desire to help players improve their athletic skills. Likewise, there is the reality that not all players can attend each scheduled game. Partially filled team rosters can be common. Every game requires effort by the coach to determine an optimal batting order and fielding roster based on multiple conditions, all while working to ensure the interests and needs of players are protected and promoted.

Coaches may spend a considerable amount of time setting fielding rosters and batting lineups for each game and for each inning of each game while likewise cross-checking to ensure league rules are not violated. Historically, fielding rosters were created on paper and modified as needed. For example, a game plan might require a last-minute change when certain players are unavailable to play because of injuries or otherwise. Ideally, coaches work to improve player skills and work to help them enjoy playing the game. These concerns likewise factor heavily into setting fielding rosters.

Technology can aid coaches in managing a team and staying in compliance with league rules and other limits placed on them or their players. However, to-date, technology aids in the form of on-line software or smart device applications generally fail to meet the broad needs of coaches to comply with rules while equally accounting for player availability, player skill levels and player development goals.

There is a need for a method of using an application which enables ease of creating a team fielding roster and batting lineup while simultaneously ensuring compliance with league rules, ensuring equity among players and promoting player development.

Although the specification describes a method for using a software application for youth baseball and softball games, the invention may be used for a range of team sports in which the creation of a game plan involving assigning players to positions and roles is necessary or useful. The present invention meets the needs set forth above.

### BRIEF DESCRIPTION OF THE INVENTION

The invention (“Invention”) is a method of using a software application (the “App”) which incorporates a range of input options based on league rules, player-specific information and related elements needed or used by coaches to optimize and streamline the creation of a batting lineup for a game and a fielding roster for each inning of a game. Data are entered into the App or used in the App in different levels. The elements of the App may include, without limitation, (i) a roster featuring all players with the ability to designate players not available for a game, (ii) a display on which to create a batting lineup, (iii) a display on which to create a fielding roster for each inning, (iv) at least one display on which to set at least one positive or negative selection bias for each player for each position of play, (v) a display on which to display player or game statistics, (vi) a display on which to enter player-selected preferences for lineup, hitting order and fielding, (vii) a display for setting inputs and notifications for rule compliance, (viii) displays for setting inputs for player development plans and (ix) displays which provide the user with heat maps and other displays depicting equity and other information concerning selections made for the batting lineup and fielding roster.

In this specification, the term “user” refers generally to a coach or manager of a team of youth baseball or softball players who uses the Invention and the App to set batting lineups and filled fielding rosters. Reference to a “positive or negative selection bias” in this specification refers to the user's perception of a positive or a negative aspect of an individual player's ability in a position in the field or at-bat used by the user to help determine and create each of the fielding roster and batting lineup suitable to support winning a game while equally supporting player development.

### BRIEF DESCRIPTION OF THE FIGURES

FIG. 1 depicts a flowchart of levels of the Invention.

FIG. 2 depicts a display of the App for the Level 1 input of data for individual players on a team.

FIG. 3 depicts the Level 2 input screen of the App for the selection of players available for a game.

FIG. 4 depicts the Level 3 input screen for the input of player metrics, limits and other qualifications of each player for selection to the fielding roster and batting lineup.

FIG. 5A depicts an unfilled fielding roster for a single inning of the game.

FIG. 5B the display of FIG. 5A showing selected players for a single inning of the game.

FIG. 6 depicts a display of the App allowing the user to select between auto draft and user-selected fielding rosters.

FIG. 7 depicts a display of the App on which the user may make a selection of certain options for use with the auto draft function of the Invention.

FIG. 8 depicts the option in the App to create notes for future use for each player in each field position.

FIG. 9 depicts an equity map in the form of a heat map of the App identifying each player and position selections for a game and further displaying compliance with set rules as part of the Invention.

FIG. 10 depicts additional features of equity map set up and use.

FIG. 11 depicts the equity map showing player fielding roster selections for each inning of a game.

FIG. 12 depicts a flow chart of the selection algorithm of the App usable for either auto draft or user selection of players for field positions.

FIG. 13 depicts a player burden and benefit list for auto draft selection.

FIG. 14 depicts a feature of the App highlighting a display when a single player (“Player B”) is selected for two positions in a single inning, thereby enabling the Invention to avoid selection errors.

FIG. 15 depicts a feature of the App which displays players on a team roster not yet selected for a position. Players highlighted in grey are available for selection.

### DETAILED DESCRIPTION OF THE INVENTION

For the purposes of this specification, the term “fielding roster” refers to the fielding positions, such as pitcher (P), catcher (C), base players (1B, 2B, 3B), shortstop (SS), and outfielders (LF, CF, RF), as those terms are commonly used in baseball. “Batting lineup” refers to the list of players on a team set in the order in which each player will be up to bat. In baseball, the batting lineup may generally remain consistent throughout a game, taking into account players benched or removed from the bench for one or more innings. “Benching” or the “bench” is used in the same way as the term is commonly used in sports, including youth sports, which refers an action by a coach to designate a player not to play for a portion of a game. Benching a player removes the player from the batting lineup and/or the fielding roster temporarily while the player is benched. Similar terms and similar designations of positions or players may be used when the App is associated with other youth sports.

The specification is properly read in terms of rules and conditions for youth sports as opposed to professional sports, college sports and similar organized sports played by adults or older children. In youth sports, the age of the players is a primary consideration for many aspects of play to protect young players from injury or other negative effects. Other considerations include working to meet the development needs of young players while promoting their mental and emotional maturation around the game.

The Invention makes use of aspects of the App, which comprises multiple operational and functional levels in which each level allows a range of inputs, calculations and/or outputs. In this specification, a “level” refers generally to display page of the App through which inputs may be made, output may be viewed, or operations may be performed. Each level may have multiple input and output capabilities. Inputs and outputs may be made serially, randomly, automatically through the App or as determined by the user. These uses of the App comprise core aspects of the Invention.

Access to the App may be open or password protected. The App permits fielding rosters for multiple games to be saved for later reference. Although access to different levels may be made in different orders, a general order of levels may be understood in terms of “first,” “second,” “third” and so forth in generally the same order as a coach would undertake to create a fielding roster and batting lineup, such as on paper.

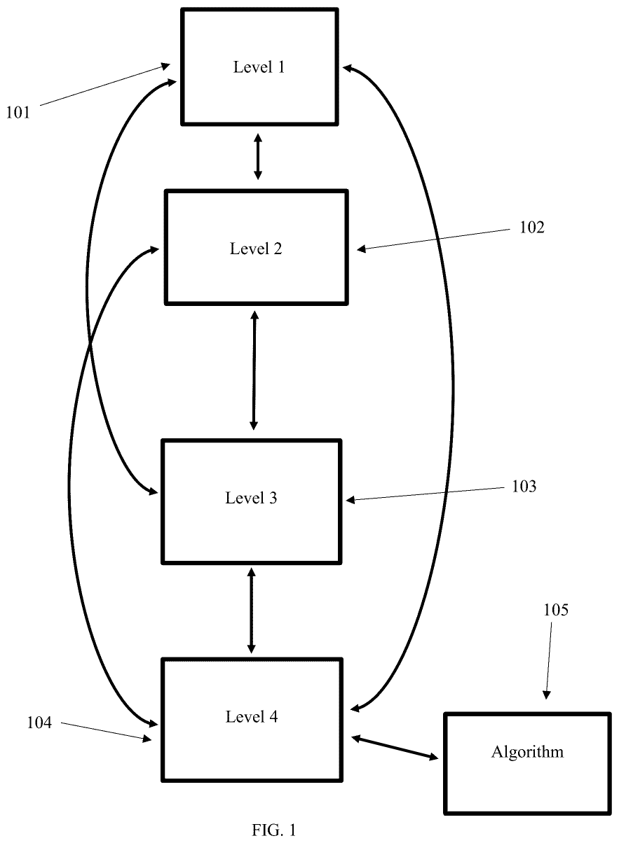

Referring to FIG. 1, a first level (“Level 1”) 101 of the App for use in the Invention allows the user to input a list of available players for a game from a list of all players on the team. Players not available for the game (not present at the game) are likewise identified. A jersey number is associated with each available player. Players identified as unavailable for the game are removed from the batting lineup and the fielding roster.

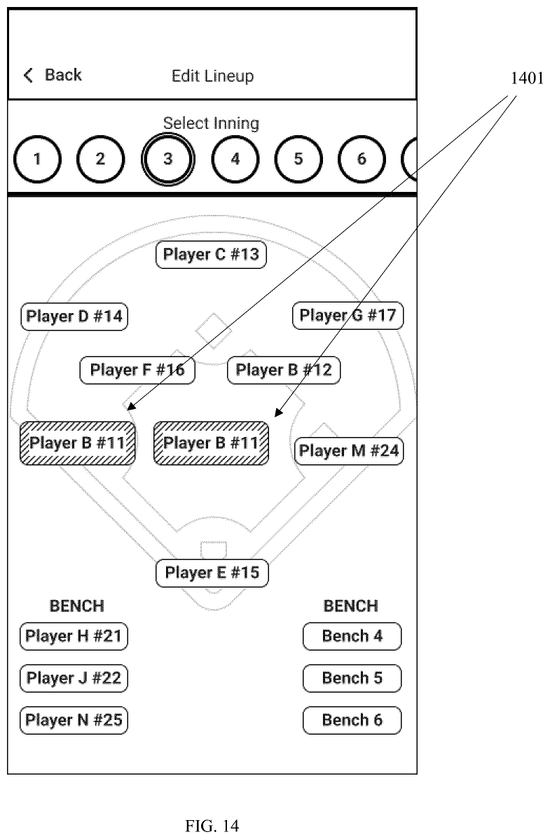

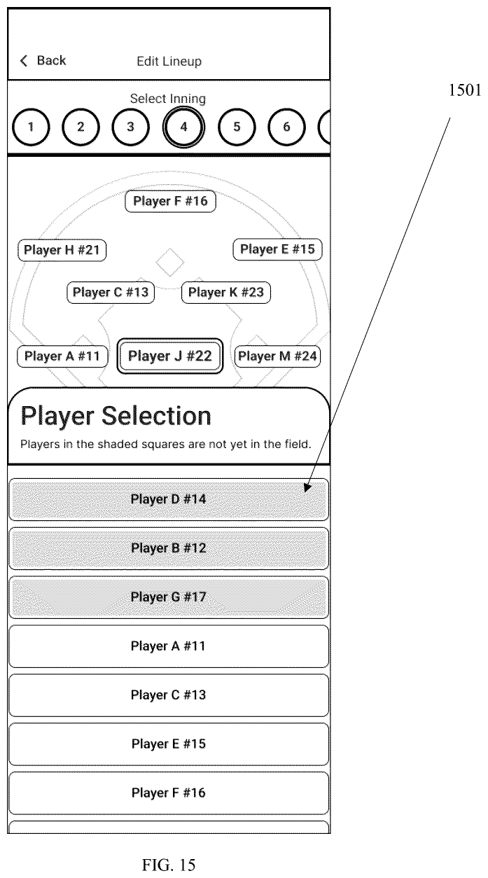

Still referring to FIG. 1, Level 2 102 of the App comprises input capability of the Invention for the user to set players available to play. Level 2 102 may be directly accessed from Level 1 101 and vice versa, if desired, in order to make changes to the player list, as needed. The player list is scaled to the number of players (generally 8 to 15). Players listed as not available on Level 1 101 are automatically removed from being set for selection in the game to either the batting lineup or the fielding roster. As depicted in FIG. 14, the App highlights 1401 any player placed twice in the batting lineup or any one inning of the fielding roster. Once the player list is entered, the App permits selection of each player from the player list to a position on the batting lineup, as described below. The list of available players from Level 2 102 is searchable. Players not yet selected for a position are highlighted 1501, as depicted in FIG. 15. Each unselected player is removed from the list once placed in a position. If a player is removed from the player list, other players move up one position on the player list. If a player is inserted into the player list, players below the inserted player are moved down one position.

Level 3 103 of the App permits a user to create a fielding roster for each inning of play. Any available player from Level 2 102 may be selected for any field position. Unavailable players from Level 2 102 are not available for selection at Level 3 103. The App highlights duplicate players for any one inning, as depicted in FIG. 14. The list of players in Level 2 102 is searchable. At Level 3 103, fielding metrics may be displayed, including, e.g., number of innings played in a position and which position was played. A player may be omitted from a lineup without “benching” the player. This feature permits players who are late for a game, who leave early or who sit out a game for an injury, not to be listed as “sat on the bench.” As depicted in FIG. 15, Level 3 103 allows the user to track players not yet selected for a position on the field for any given inning during the selection process. As described in more detail below, the user may assign a ranking to each player based on the user's assessment of the player's skills in different positions. This ranking can then be used through the App in using the Invention to create a balanced fielding roster. The Invention permits the user to return to Level 1 101 or Level 2 102 from Level 3 103 and back, as needed and player availability will be subsequently updated.

Playing in a position requiring more physical exertion or skill may impose a deficit on that player. A user may use the App at Level 3 103 to set a limit or restriction on further use of a player in a position based on the number of times that player played that position in the game. The user may set a number of innings the player is restricted from playing in a position during a game before being allowed to return to that position. By using the App in there ways, the user may take advantage of the Invention to optimize player selection.

In brief, Levels 1 through 3 (101, 102 and 103) provide aspects of the Invention, using the App, for the input of information about players, their skills, deficits and other qualifications to enable the displays of the Invention. The App allows the user to enable input options relative to positive and negative selection biases specific to each player, such as player skill (or a lack of skill) in a position or at batting, inning limits based on age or other factors, or a desire to provide a player additional training in a position or increase sport safety by restricting unskilled players from being placed in vulnerable positions on defense. The App likewise permits other selection information to be inputted.

The descriptions of Level 2 102 and Level 3 103 of the App are general in nature and not limiting. Each of Level 2 102 and Level 3 103 may be adapted and refined to upgrade the App and the Invention to improve functionality for player selection. For example, the positive and negative selection biases designated for each player may be revised and improved without varying from the general description of the invention herein. Further, additional levels may be added to the App to improve functionality. Steps of the Invention may be interchanged or expanded. The description of four levels herein is made to show basic functionality of the App for use in the Invention.

The data entered in Levels 1 through 3 (101, 102 and 103) are selectively used and displayed on Level 4 104, which comprises displays, notifications, game and season metrics, as described in more detail below. Level 4 104 may be accessed from any of Level 1 101, Level 2 102 or Level 3 103 and each of these three layers may be randomly accessed from any other layer as needed to update information before or during a game, as reflected by the arrows depicted in FIG. 1.

Displays provided on Level 4 104 are generated from inputs made in Levels 1 through 3 (101, 102 and 103) and may include, without specific limitation, an ability to track the number of times a player is slotted to play a certain infield position for each game or the ability to track the number of times a player is slotted an outfield position. Displays on Level 4 104 are enabled by association with a software algorithm 105 which assesses, optimizes and otherwise makes use of inputs from Levels 1 through 3 (101, 102 and 103) as well as pre-selected positive and negative selection biases. In using the Invention, these displays may provide information in numerical format (e.g. listing the number of times a player played in a certain position) or by color coding (using one color to identify a player who has played more than a set number of innings in a specific position during a game and a different color to identify a player who has not reached a set number of innings in a certain position). A further different color may be used with a player for whom there is no limit on playing a certain position. Using the Invention, Level 4 104 permits the user to identify the player(s) slotted for the most or fewest times in the outfield, for example, or the number of times a certain player is slotted to (i) play pitcher, (ii) catcher, or (iii) sit on the bench. Level 4 104 likewise permits the user to track which players are on the bench the most or the least. No “out of App” notifications are necessary.

Level 4 104 permits the user to use the App to configure the display of statistics by type and order of presentation. Tracked statistics may include times at bat (AB), batting average (AVG), on-base percentage (OBP), strike outs (SO) and others. In using the Invention, Level 4 104 statistics may be displayed while the user is selecting players for the batting lineup. Similarly, Level 4 104 tracks and displays fielding statistics, such as fielding percentage (FPCT), errors €, total chances (TC) and others.

The user may enter data as the game is played, generally through Level 2 102. Furthermore, statistics may be entered manually by the user or automatically through one or more application programming interfaces (each an “API”) which may be associated with the App. Using an API, data may be entered automatically into the App from other game tracking applications to compile statistics that are not tracked through the user input directly.

The Invention comprises an “Auto Draft” feature enabled by an algorithm 105 which is part of the App. Each player may be assigned preset preferences. For example, player A may be assigned positive bias for LF, CF, 2B or P. In this disclosure the following terms are used: P=Pitcher, C=Catcher, SS=Shortstop, 1B=First Base, 2B=Second Base, 3B=Third Base, LF=Left Field, CF=Center Fielder and RF=Right Field. Players placed on the fielding roster are commonly selected in this order of positions. Algorithm 105 likewise enables equity maps displayed by the App.

When each player is assigned his or her positive or negative selection biases by the user, the auto draft of the Invention feature may be used to generate an entire fielding roster and batting lineup for a game based on any number of innings and using 8 to 15 players. Auto draft may create a batting lineup or fielding roster for an entire game, a single inning or for multiple innings of a game. The user controls the auto draft and may override the auto draft selections for one or more players or one or more positions.

As data are loaded into the App during game play, algorithm 105 tracks each player's data against pre-set conditions, such as league rules or identified preferences. Data are used for making later auto draft selections or later manual selections. For example, the App will provide a notice when a player has pitched too many innings in a single game, based on a limit set by the user or by league rules. The form of notification can vary based on user preference. For example, the notice may block the entry of further data input or may act in the form of a second-tier type of notice, such as a color change as to the player or a badge or icon posted in association with the player, to alert the user to change out the player from that position. Alerts may be based on the number of pitches pitched or the number of full innings played (such as 3, 4 or 5). Partial innings are logged based on the number of outs recorded—for example, 2.1 or 2.2 innings. In an alternative embodiment, the App may display a warning notice to the user that the desired action violates a league rule or violates a pre-set condition.

The App likewise provides alerts that a player has sat on the bench too many innings in a game. The user may configure the App either to reject the user's selection to make the player sit the bench or provide a warning to the user that the action violates a set condition. By using the App in this manner, the Invention provides immediate feedback to the user during the fielding roster or batting lineup selection process.

The App permits the user to set and manage pitch limits for multiple pitchers. The user may assign a pitcher to rest for an entire game, group of games or a set number of calendar days.

The App provides a drag and drop capability for the feature and may be linked to preferences set by the user. Because different leagues may have different rules, pitcher rules may be configured by the user in the App during set up. The App may be configured for “Little League Game” or “Tournament Play,” and apply different preset preferences for each.

The App harvests and analyzes data from games completed (“GC”) to make predictions in algorithm 105 about how many pitches or innings a pitcher should play in a game. For example, the App may generate a prediction such as, “based on the athlete's pitch/inning stat so far this season, and the opponents' high batting average, your starting pitcher may be expected to reach his pitch limit during the 3^{rd} to 4^{th} inning.” These predictions enable in part the Invention.

In an embodiment, the App, via algorithm 105, permits a user to use the Invention to create a development plan for each player. For each player, the user may set goals, specific or general, for player development. The App permits the user to assess and record player skill level at each position. Likewise, the App permits the user to set plans for playing time for each player. The App permits the user to flag a player for having played the same position too many times. For example, a player may be flagged if set to play shortstop too many innings or for playing in the outfield too many innings without playing, for example, 1^{st} base.

As described in more detail below, the Invention optimizes use for direct user selection by providing alerts in some form to favor or disfavor the selection by the user for a certain position. While the user can make a selection contrary to alerts provided by the App, the Invention enables the App to provide a notification of a selection contrary to the alert. At the same time, the auto draft feature uses user input and data in the form of the positive and negative selection biases to create a weighting system used in auto draft mode to select players for the batting lineup and fielding roster based on the results of the user input using a software algorithm.

The functionality of the Invention is most easily depicted in representative screen shots of the App in use.

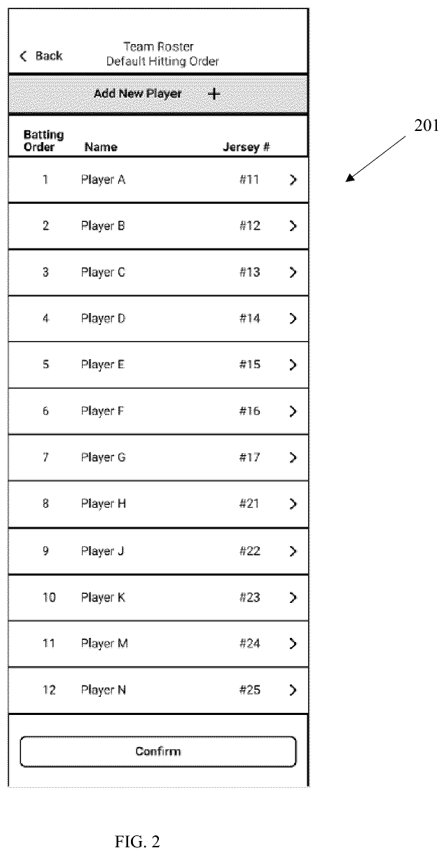

Referring now to FIG. 2, a sample team display 201 of Level 1 101 input of a team is depicted. Each player is listed individually and is assigned a jersey number in team display 201. Jersey number selection may be automatic or by user preference. For example, in FIG. 2, Player A is assigned jersey number 11.

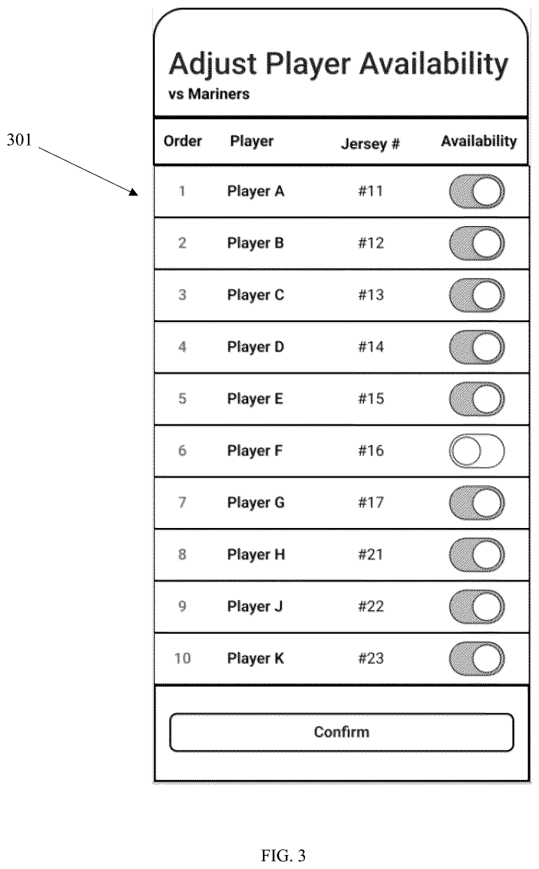

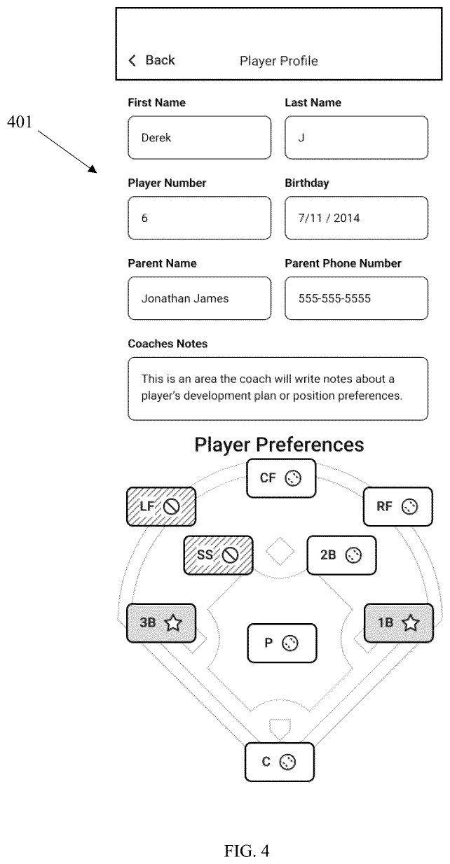

Referring now to FIG. 3, players on the team roster input in Level 1 are designated as either available for play or not available for play in an availability list 301. For example, in FIG. 3, player F is designated as not available. All other players are listed as available. Referring to FIG. 4, for each player, the user may input positive and negative selection biases in selection biases input 401 to be used in the Invention for selection of that player to the fielding roster and batting lineup. For example, in FIG. 4, details of player Derek J are listed. FIG. 4 depicts player Derek J as not eligible or suitable to play 1B and 3B. This is reflected by both color and icon.

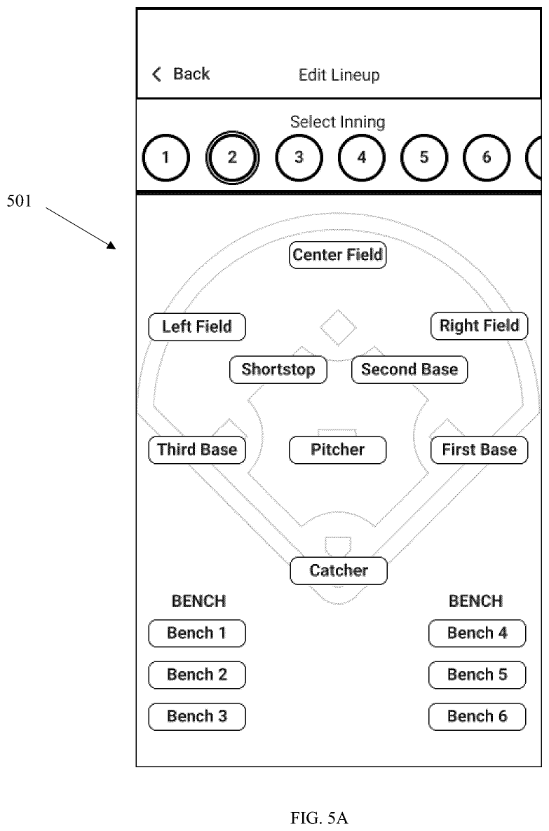

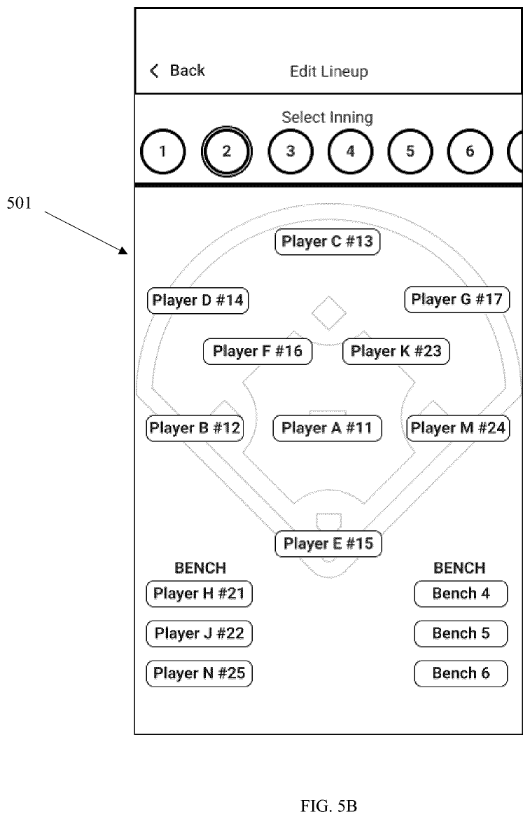

Referring now to FIG. 5A, aspects of Level 4 functionality are depicted. FIG. 5A depicts a representative field display 501 of the Invention showing a baseball field and each field position. The user may select players for each position, with benched players not selected. In field display 501, a single inning's fielding roster is to be filled. The Invention permits selection of multiple innings or an entire game at once. The Invention assesses each player selected for a position against the preset positive and negative selection biases, such as number of innings previously played in the position, user determination of player skill in the position, player need for improvement in the position or otherwise. Players who are selected for a position consistent with the positive preset selection biases are displayed in green. Players who are selected for a position inconsistent with positive preset biases are displayed in red. Coloration is representative and not a limiting factor of the Invention. Color coding is described in more detail below. Visual, audible or even haptic displays could be enabled.

Color-coded displays allow the user to have immediate visual reference as to whether each player is selected in accordance with the user's preset selection biases. This permits the user to set a uniform rationale for fielding roster selection or, if helpful, to make selections which are inconsistent with the preset selection factors but for which an exception makes such a selection useful.

Referring to FIG. 5B, field display is depicted with players assigned to field positions, although color coding is not depicted in this figure. For example, in FIG. 5B, player F, number 16, is selected to play shortstop.

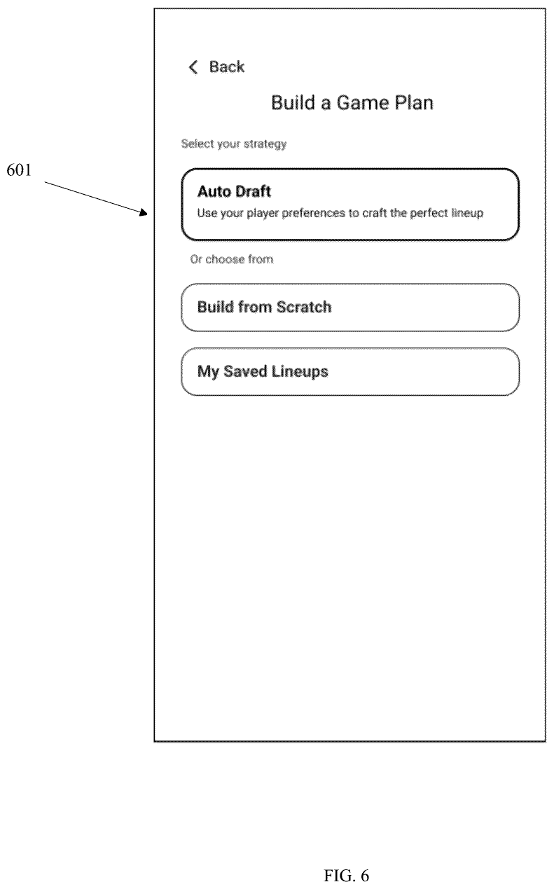

As aspect of the functionality of the Invention is depicted in FIG. 6 as to selection between auto draft and user-created fielding rosters in selection screen 601. For each game, the user, after entering all player information, may elect to use the auto draft function of the Invention to create a fielding roster and/or batting lineup or build them directly. In a further option, the user may use a previously created lineup or fielding roster or may use those used in a previous game.

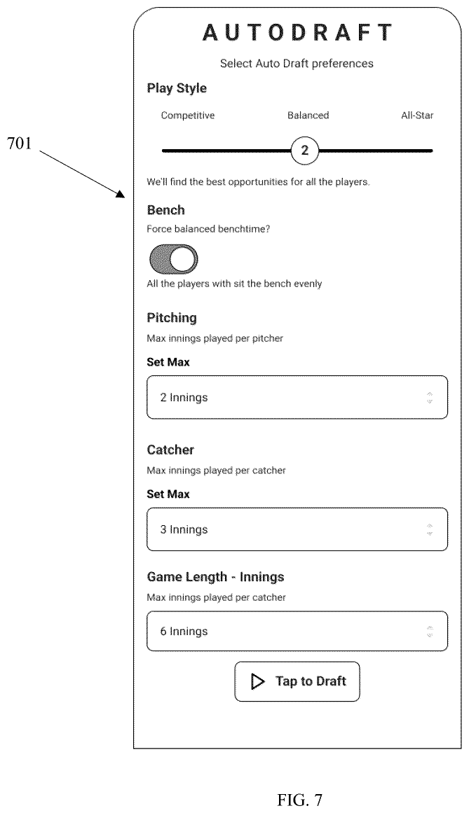

Referring now to FIG. 7, when the user makes use of the auto draft function of the Invention, the user may enter additional conditions and factors for player selection. As depicted in the auto draft selection display 701, these may include balancing experienced players with less-experienced players. The auto draft selection display 701 in FIG. 7 permits a sliding selection between balanced play, competitive play and all-star play. Likewise, the Invention permits the user to select factors for placing players on the bench, including, for example, a cap on the number of innings a player may be benched during auto draft. Further, auto draft functionality permits the user to set a limit for auto draft for the number of innings a player may play a specific position. FIG. 7 depicts a limit of two innings for a player to play at the pitching position and 3 innings as catcher.

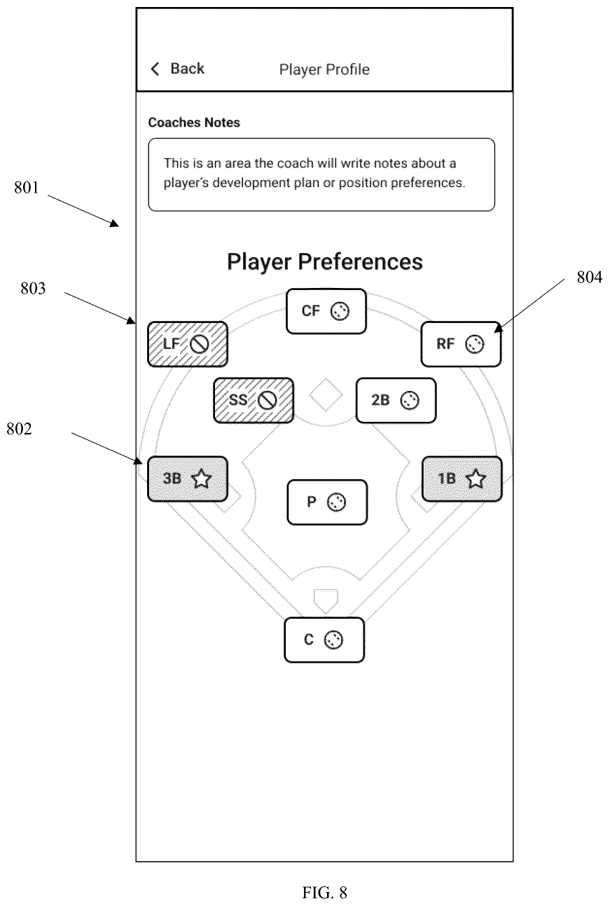

Referring to FIG. 8, in player profile mode, the user may set a list of player preferences for each position in the field on a player preference screen 801. Preferences for each position are displayed in the form of an icon representing player preference between high, medium and low. The user may add notes as to specific areas of interest of the player in each position. FIG. 8 depicts the color green referenced above in grey shading (e.g. 3B) 802 and the color red depicted in hatched shading (e.g. LF) 803. An icon is associated with each color. Here, a star icon represents a positive selection bias. A baseball icon 804 represents a basic skill level and a circle with line through it representing a negative selection bias.

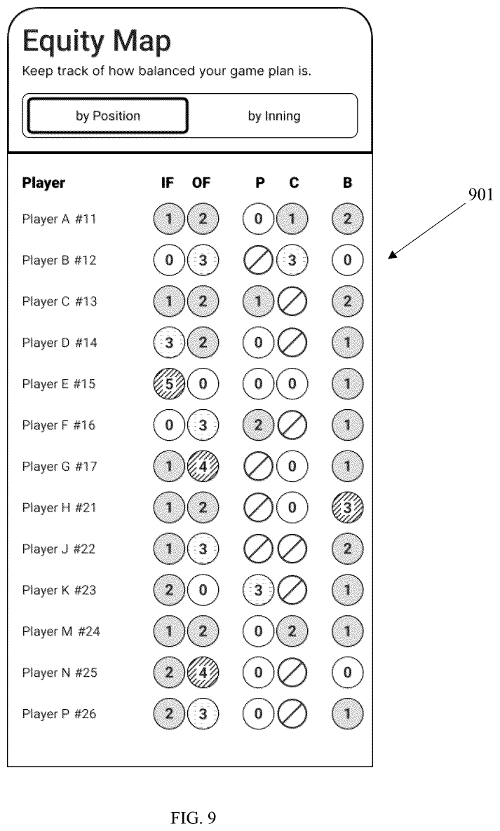

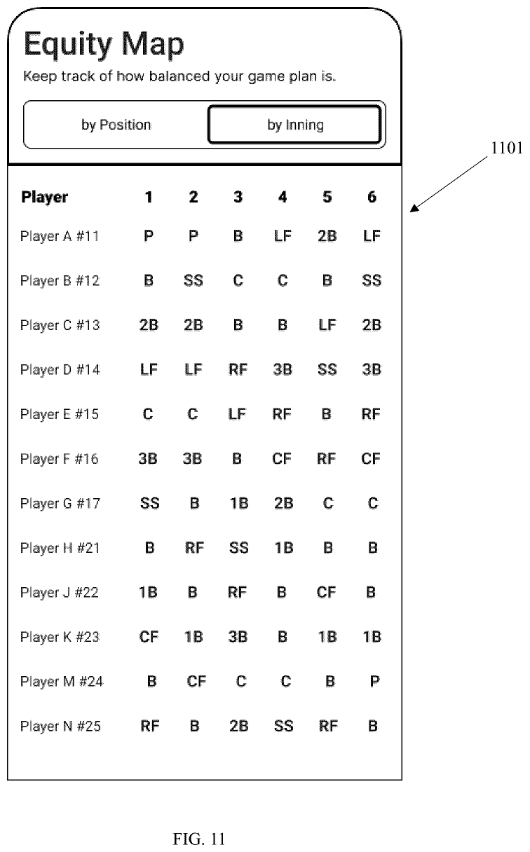

Referring now to FIG. 9, an equity map 901 is depicted. An equity map is a feature of the Invention taking the form of a heat map showing in color coding adherence of the user to the player selection factors. The equity map 901 shows the number of innings played by each player in each position of the game. The color red (hatched) may show, for example, a player selected for more innings than preset by the user. The color green (grey scale) shows a player selected within the limits preset by the user. Other colors (horizontal dashed grey scale) may also be used to warn of approaching limits. The color red may likewise depict a player who is not selected enough times or set too many times for a position in the field or on the bench. FIG. 9 depicts the equity map 901 by the number of innings. It may likewise be set to display by inning, as depicted in FIG. 11.

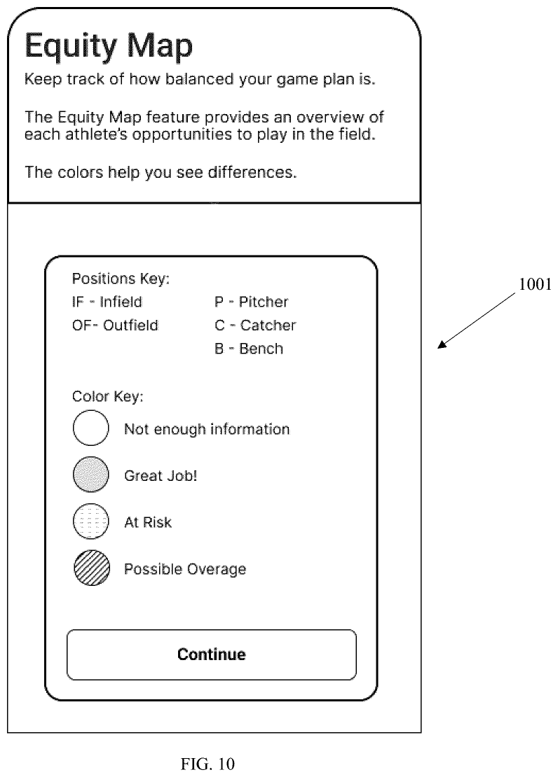

Referring also to FIG. 10, the equity map 901 of the Invention provides guidance to the user about the meaning of color coding, as described herein. Coloration is representative and not a limiting factor of the Invention or the App.

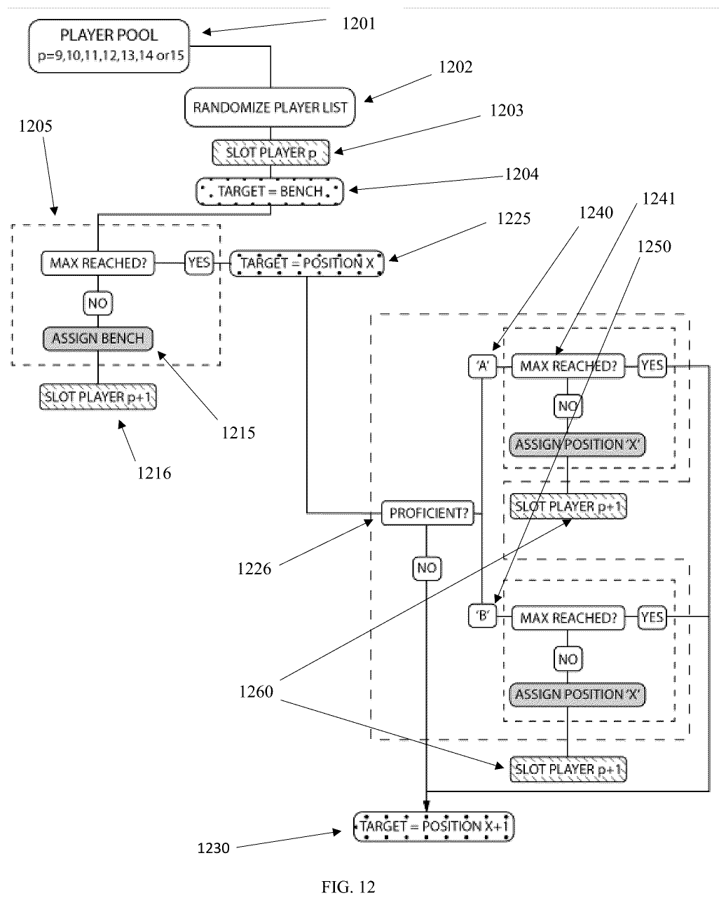

Referring to FIG. 12, a flow chart depicts the general algorithm of the App used in the Invention for selecting players for, for example, the fielding roster. The algorithm depicted in FIG. 12 is the format used for auto draft and is equally useable for user selection of positions. The following description depicts an auto draft use of the algorithm.

In a representative example, the user enters a list of available players into the player pool 1201. The Invention randomizes the player list 1202. It then evaluates, at 1203, each of the randomized players for selection to the bench, at 1204. Evaluation is based on user-defined positive and negative selection biases entered into the App with the entry of the player pool 1201. The Invention assesses whether the maximum number of players 1205 has been assigned to the bench at 1204. If not, then player 1 is assessed for assignment to the bench at 1215. If player 1 is assigned to the bench at 1215, the Invention moves on to player 2 at slot player p+1 1216. However, if player 1 is not assigned to the bench at 1215, player 1 is assessed for assignment to position 1 1225. Position 1 1225 is typically the pitcher, with other positions assigned in the order previously described. The user may define any position selection order desired.

FIG. 12 depicts a dotted box surrounding the elements of the flow chart describing the fielding roster position selection algorithm of the Invention. The dotted box represents the need for repeated action for each player and each position, as applicable to the stage of selection. Player 1, in this example, is assessed for proficiency 1226 for position 1 1225. Proficiency 1226 is assessed according to the positive and negative selection biases entered by the user. If player 1 is determined not to be proficient at position 1 1225, player 1 is assessed for position 2 1230.

If player 1 is assessed as proficient at 1226 for position 1 1225, player 1 is further assessed for position 1 1225 based on one or more qualifications ‘A’ 1240, ‘B’ 1250 or as further set by the user. Qualifications ‘A’ 1240 and ‘B’ 1250 may include positive and negative selection biases as set by the user. For example a player's preferences may be as in FIG. 8 above. ‘A’ corresponds to a star player 802 while ‘B’ corresponds to a basic skill level player 804 in the position in question. Likewise, qualifications ‘A’ 1240 or ‘B’ 1250 may assess whether player 1 has not yet played in a position a set maximum number of times 1241.

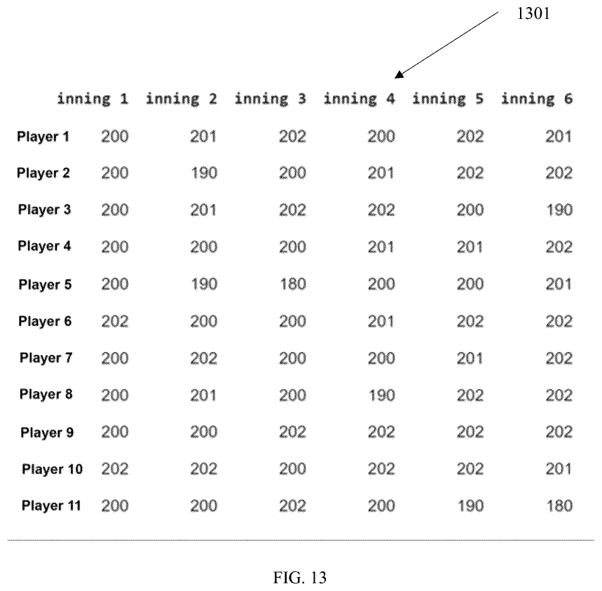

As described previously, playing in a position may impose a burden on a player, thereby reducing the likelihood of that player being selected for that position again in the game and thus limiting that player from playing that position more than a maximum set number of times 1241. Equally, not playing in a certain position in an inning may provide a player a certain benefit, which increases the player's chance of selection for that position later in the game. These burdens and benefits may be assigned a numerical value, such as depicted in FIG. 13. As depicted in FIG. 13, each player begins a game with a set point value, here shown as 200. Playing in a certain position in the first inning provides some players a burden, resulting in a number value being added to the player's total. For example, player 1 has had one point added to the player's total. This higher number may be associated with an increased chance of selection for a favored field position in the second inning. In this example, player 2 played a more desired position in the first inning, resulting in a benefit to player 2. As a result, player 2 has 10 points removed from player 2's point total, making it less likely player 2 would be selected for a more desired field position for the second inning.

In using the Invention, any qualification A 1240, B 1250, or other qualification may be assessed on a basic numerical value (such as the number of innings the player previously played the position in the game) or on the more general numerical assessment depicted in FIG. 13.

In either case, if player 1 is selected for position 1 1225 at 1260, the Invention moves forward to player 2 for the next position. If player 1 is not selected for position 1 1225, player 1 is assessed for the next position 1230. This process is repeated until all positions are filled for all innings of play.

It should be understood that the flow chart of FIG. 12 and the scoring system of FIG. 13 are representative only. Either may be modified in any manner consistent with the goals and purposes of this specification.

We claim:

1. A method of creating a game plan for use in a youth sport game comprising the steps of:
a. uploading a designated software application onto a suitable electronic device able to operate the software application;
b. inputting into the software application a list of players for the youth sports game;
c. designating for a specific youth sports game those players from the list of players that are not available to play the specific youth sports game;
d. designating for a specific youth sports game players to be placed on the bench;
e. inputting into the software application for each player on the list of players one or more positive or negative selection biases;
f. inputting into the software application for each player on the list of players one or more player position preferences;
g. inputting into the software application for each player one or more comments concerning aspects of the player's position preference or development goals;
h. selecting from the list of players on the player's list one player for each position on the playing field of a youth sports game;
i. using the software application to generate one or more equity maps showing compliance in the selection of each player as to each position relative to the one or more positive or negative selection biases;
and
j. based on previous player position selection, generating in the software application a positive or negative point value assigned to each player in each selected position to be used in the software application for future position selection.

2. The method of claim 1 in which the software application includes the step of allowing a user to make player position selection directly through the software application.

3. The method of claim 1 in which the software application includes the step of allowing a user to make player position selections through an auto draft function of the software application.

4. The method of claim 1 in which equity maps may be displayed based on positions of team play.

5. The method of claim 1 in which equity maps may be displayed based on periods of play.

6. The method of claim 5 in which the displayed periods of play may be innings of play.

7. The method of claim 1 in which a selection bias may be based on setting a maximum number of periods of play in a position of play for a player.

8. The method of claim 1 in which a selection bias may be based on setting a minimum number of periods of play in a position of play for a player.

9. The method of claim 1 in which a selection bias may be based the user's assessment of a player's skill in a position of play.

10. The method of claim 1 in which a selection bias may be based on a player's position of play preference.

11. The method of claim 1 in which the youth sports game is a baseball game.

12. The method of claim 1 in which the youth sports game is a softball game.
